(19) United States
(12) Patent Application Publication
(10) Pub. No.: US 2023/0137308 A1
(43) Pub. Date: May 4, 2023

(54) PROVIDING DATA INTEGRATION WITHIN A REAL-TIME DATA SCIENCE PLATFORM

(71) Applicant: Nextqore Inc, Reston, VA (US)

(72) Inventor: Suresh Madihally Rangachar, North Potomac, MD (US)

(21) Appl. No.: 17/980,449

(22) Filed: Nov. 3, 2022

Related U.S. Application Data
(60) Provisional application No. 63/275,411, filed on Nov. 3, 2021.

(51) Int. Cl. G06F 16/25; G06N 3/08; G06F 16/908

(52) U.S. Cl. CPC G06F 16/252; G06N 3/08; G06F 16/908

(57) ABSTRACT

The systems and methods described herein provide for data integration within a real-time data science platform. A dynamic, real-time data sourcing architecture is provided, which allows for a comprehensive and flexible definition of the sourcing of data. The architecture enables modifications to be made to initial definitions using actual measurements. The combination of these two steps achieves a highly useful set of real-time data sources in order to improve the operation of physical objects.

### CROSS-REFERENCE TO RELATED APPLICATIONS

This application claims the benefit of U.S. provisional application No. 63/275,411, filed on Nov. 3, 2021, the entirety of which is incorporated herein by reference.

### FIELD

The present invention relates generally to business intelligence and analytics, and more particularly, to methods and systems for intelligent quantification of business phenomena.

### BACKGROUND

Within the business world, there are always struggles with keeping costs low, keeping quality high, and ensuring production and services are performed on time or ahead of time. These aspects are becoming increasingly more difficult to manage for a number of reasons. One reason is that technological change occurs at a rapid pace. Another reason is that health, safety, and environmental regulations and compliance requirements have become increasingly stringent in parts of the world, which leads to constraints on one or more of these goals. As a result, data science plays a key role in identifying the sources of such constraints and delivering a number of insights for businesses. Such insights include cost insights, quality insights, and service or delivery-on-time insights. A major need in the industry is for business intelligence and analytics to deliver such insights for the purpose of building and maintaining digital operations.

Some solutions for providing these insights attempt to define the digital sensors in operations, or define digital twin methods in system simulation, i.e., defining a virtual model designed to accurately reflect a physical object. For example, digital sensors may produce data about different physical aspects of the physical object's performance, such as energy output, temperature, weather conditions, and more. This data may then be relayed to a processing system and applied to the digital “twin” or copy of the physical model. However, these solutions currently fail to meet the needs of the industry. A large amount of data collection is required, which first needs to be collected from the sources, then configured to identify whether the data comes from a controlled or uncontrolled environment and to additionally identify recovery features so data can be recovered from the field if needed. Other aspects of the data, such as acceptable ranges for the data within specific contexts, must also be identified. The current digital twin offerings in the industry have major flaws in this collection and understanding of the data. As such, much of the data is often either not properly collected, or unusable for operational insights.

Currently, there are a number of solutions for data processing and analytics to provide insight into business operations. Some of these solutions also connect to real-time sources such as Internet of Things (hereinafter “IoT”) sensors using different connectivity methods. However, none of these solutions are designed to operate upon and understand variations of real-time data from different sources. The solutions also fail to be flexible, multi-source in nature, and capable of determining the best approach in real time for how to use data to best suit various business operations.

These current solutions treat the sensors and the telecommunication network as “black boxes”, and do little to measure their constant uptime and contribution to a robust data pipeline which can be used for decision-making in the operation of assets or physical objects. Some of these solutions attempt to provide the ability to add a processing function, yet fail to specify what to process as well as what the impact on operations would be.

In addition, real world operating scenarios often require working with actual data and not with simulated data. Some solutions attempt to solve this problem by employing extra sensors with better edge processing, but these solutions are unable to meet the needs of the industry for the same reasons cited above.

Thus, there is a need in the field of business intelligence to create new and useful systems and methods for providing data integration within a real-time data science platform, such that the usage of machine data can be enhanced and rendered more useful in individual user and business environments. The source of the problem, as identified by the inventors, is a lack of a data science platform which can address ways of performing data flow fully digitally, while also enabling use of this data for various individual customer and business trends. Such a data science platform also must use this data to improve the individual efficiency of and quality of business outcomes. Such a data science platform should also employ artificial intelligence (hereinafter “AI”) techniques and methods for digital states to enable more precise, intelligent, and data-driven outcomes for businesses.

### SUMMARY

The systems and methods described herein provide for data integration within a real-time data science platform. A dynamic, real-time data sourcing architecture is provided, which allows for a comprehensive and flexible definition of the sourcing of data. The architecture enables modifications to be made to initial definitions using actual measurements. The combination of these two steps achieves a highly useful set of real-time data sources in order to improve the operation of physical objects.

Furthermore, the methods and systems herein operate to continuously ensure each source, whether the source is structured or unstructured, is working per requirement to produce reliable data. These systems and methods additionally provide feedback to customers or users on possible improvements to the source design that is being deployed.

The disclosed systems and methods fulfill these needs and address the aforementioned deficiencies by providing an initial model for data sources in an expansive, complete model, by employing techniques for measuring the effectiveness of the system to operations, and, in some embodiments, by producing reports to further improve the real time source design for improved efficiency and quality as well as lowered cost.

### BRIEF DESCRIPTION OF THE DRAWINGS

These drawings and the associated description herein are provided to illustrate specific embodiments of the invention and are not intended to be limiting.

FIG. 1A is a diagram illustrating obtaining data based on defined source sensors, in accordance with some embodiments.

FIG. 1B is a diagram illustrating obtaining granular data for physical objects mapped to sensors, in accordance with some embodiments.

FIG. 1C is a diagram illustrating maintaining details of sensors and a gateway, in accordance with some embodiments.

FIG. 1D is a diagram illustrating methods of reconfiguring a sensor definition after operational experience, in accordance with some embodiments.

FIG. 2 is a diagram illustrating connecting to image processing systems to obtain states of physical objects for performing actions, in accordance with some embodiments.

FIG. 3A is a diagram illustrating obtaining data from an application programming interface for sourcing and structuring purposes, in accordance with some embodiments.

FIG. 3B is a diagram illustrating sourcing data from standard computing devices, in accordance with some embodiments.

FIG. 4 is a diagram illustrating a function to provide continuity of source data, in accordance with some embodiments.

FIG. 5 is a diagram illustrating validation and verification of acceptable data ranges for structuring the data into further processing operations, in accordance with some embodiments. The figure also illustrates handling of missing data or invalid ranges by issuing notifications to improve the continuity or valid values of source data, in accordance with some embodiments.

FIG. 6 is a diagram illustrating collection of statistics for providing a snapshot view of consistency and reliability of data sources, in accordance with some embodiments.

FIG. 7 is a diagram illustrating an exemplary computer that may perform processing in some embodiments and in accordance with aspects of the present disclosure.

### DETAILED DESCRIPTION

In this specification, reference is made in detail to specific examples of the systems and methods. Some of the examples or their aspects are illustrated in the drawings.

For clarity in explanation, the systems and methods herein have been described with reference to specific examples, however it should be understood that the systems and methods herein are not limited to the described examples. On the contrary, the systems and methods described herein cover alternatives, modifications, and equivalents as may be included within their respective scopes as defined by any patent claims. The following examples of the systems and methods are set forth without any loss of generality to, and without imposing limitations on, the claimed systems and methods. In the following description, specific details are set forth in order to provide a thorough understanding of the systems and methods. The systems and methods may be practiced without some or all of these specific details. In addition, well known features may not have been described in detail to avoid unnecessarily obscuring the systems and methods.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

The systems and methods described herein are unique in a number of ways. One such way is that data sources, such as sensors, are defined within the context of various equipment's performing their functions or Operations (i.e., designated business operations), and changes to those data sources are made in the context of such Operations. The previous solutions in this field defined a digital twin as a simulation of its twin physical object. In contrast, the present systems and methods directly involve various Operations to provide a near accurate picture of given physical objects, as well as correct any manufacturing, installation, and/or environment limitations to be adjusted in Operations to run the physical objects more efficiently.

In some embodiments, systems and methods are made up of the following components: (1) a set of data tables which represent a set of sources, (2) the set of sources, which can include, e.g., sensors or the digital output of image processing as a “Digital Twin”, and (3) a clear definition of what essential elements, in granular detail, the source is representing out of the physical object.

In some embodiments, the system enables configuration of a comprehensive database definition of source for a location/environment, a set of Equipment, a component within the equipment, and a sub-component within the component. The database represents such sensors to generate data periodically. The defined source mapping represents various data such as, e.g., manufacturing data, installation data, and mapping to operations, which can be used to accurately estimate how well the source is functioning.

In some embodiments, the system also allows making modifications to the definition, including adding new sensors, or modifying the currently defined sensor and keeping the record of changes made in the definition.

In some embodiments, the system allows other system systems to query and obtain the mapping configuration.

In some embodiments, the system may also have one or more of the following optional components:

(a) The system may include environmental data as an optional component along with the sensor or other source data.

(b) Additionally, some of the sensor parameters can be passed to other modules to operate the defined sensor for various purposes, such as structuring the data from the source to produce a robust data pipeline. Such a data pipeline can be used to monitor and manage the assets for better performance at optimized cost.

(c) The system can interface with other modules that monitor and interpret the data stream to obtain actual performance data. Such data can be presented to the user as a guideline for reconfiguring the definition for better results.

The disclosed systems and methods are unique when compared with other known systems and solutions in that, in various embodiments:

(1) They provide a starting definition of mapping the sensors and allowing changes to be made to the definition dynamically for improvement in actual real-life measurement.

(2) They provide a full definition of the parameters of the physical objects to sensors and other sources. The full definition goes into details of the installation such as, e.g., redundancy (for no single point of failure), synchronization (to get correlated data at the same time from different points of physical objects), and so on.

(3) They consolidate a number of locations for a set of equipment to be operated for a customer or user.

(4) They can learn from other modules or external components the actual performance with respect to expected behavior, and allow users to make changes to the definition of the sources of data and the correlation to customer equipment or assets.

The disclosed systems and methods are also unique in that the overall architecture of the system structurally aligns as much as possible with the customers' organizational prevailing practice. The system keeps all of the aspects of designing, deploying, and modifying within the actual field operations domain. Such approach eliminates the need to simulate first and then take the results to actual operation later.

The system is configured to represent the source data as a dynamic number of inputs. More specifically:

(1) It provides the industry's only comprehensive, integrated and cohesive definition of the physical object to mapped sensors that can produce the data;

(2) It allows changes to be made dynamically to derive improved precision and efficiency for the first time; and

(3) It can be employed for improvement of actual asset functionality and for reduced costs.

In addition to industrialized purpose-built sensors, it would be desirable to capture the states of the device and the applications and publish them within a cloud-based location. It would also be desirable to capture data using Bluetooth, Wi-Fi, or similar technologies and publish that captured data to the cloud. Such captured data is usable in a business environment to determine the productivity of the person or a business process using the devices.

In some embodiments, the disclosed systems and methods advantageously fill these needs and address the aforementioned functionality by providing a method to define a set of functions that communicate with the cloud per the digital data determined to be sent to the cloud.

Furthermore, in some embodiments, the system is capable of allowing the customer to define if that data has to be analyzed and kept for their use only or can be shared with other users—as defined by them.

The disclosed invention is a system together with an associated computer system.

In various embodiments, the system can include one or more of the following components:

State Measurement and Data centralization to the Cloud. This may include one or more of the following:

(1) A component that connects a data device (such as a mobile phone, desktop computer or a laptop to the cloud). Each such data device will be configured in a secure way (certificate) to communicate the states to the cloud. It can include optional components to throttle the periodicity with which the data is sent. The component will have the capability to send information to multiple cloud with individual certificate.

(2) A component that can also store such information to upload to the cloud if the network connectivity is lost. The information will be sent once the network connectivity is restored.

(3) A component which interfaces with the device operating system (hereinafter “OS”) to obtain device level information.

(4) A component which interfaces using the communication capability of the device, such as, e.g., Bluetooth, Wi-Fi, or Near Field Communication (“NFC”). It provides the configuration of what information is obtained using the local communication interface and how to send the information to the cloud.

(5) A component that can-do critical connectivity and performance of the network that the devices are connected to the Internet or VPN and produce data points. These are configurable to be published to the cloud.

(6) A component that interfaces with many applications and utilities on the phone or such device and generates states from those and publishes the information on the cloud.

(7) An optional component that sets up the account management, billing and service related information for the device to use the cloud service.

In various embodiments, the system may also have one or more of the following components:

(8) A component for making recommendations based on usage analysis of the physical object being measured with the data.

(9) A component for making recommendations on the frequency of data upload.

(10) A component for making recommendations on the data quality improvement.

The disclosed system is additionally unique when compared with other known systems and solutions in that in some embodiments, it provides immediate access to using a digital framework that produces usable states that can be used for data, without users actually performing data entry functions to achieve the end goal in a way that is useful for various business and consumer applications. It makes it usable by people of different levels without knowing explicit applications to establish various social interfaces, since the system reads the states and publishes them within a machine-to-person framework.

The disclosed system is additionally unique in that the overall architecture of the system is different from other known systems. More specifically, in various embodiments, it provides one or more of:

(1) a defined building block to design and capture the state and data;

(2) the use of soft operational methods to publish the data in a secure way; and

(3) the ability to work within natively digital methods to improve the lifestyle of consumers or performance of the business using the data measured.

In some embodiments, such data from devices can be also obtained by using web technologies, rather than the conventional process of running an application on the device.

Additionally in some embodiments, data can be sourced using an Application Programming Interface (hereinafter “API”) to other applications to connect to a database directly to obtain data. It is desirable to use such an approach if the data is readily available as obtained from other systems that are connected for enhanced processing.

Whatever methods the data is sourced from, the integration of the sources that represent a complete data set that is considered reliable for later use in data science is called structuring the data. In order to achieve this, it would be desirable to have a way to manage the uptime of sensors, since they are the fundamental blocks that produce data. Specifically, the Architecture must ensure the resolution of any instability in operations or factors that are due to manufacturing errors, installation issues, configuration errors, or environmental instabilities. Such instabilities must be corrected for enabling the operational sensors to produce continuous and reliable data.

Furthermore, it would be desirable to have a system that clearly identifies the reasons for failure, raises timely and accurate root cause alerts to fix the errors to make the current installation robust, and uses the experience for future deployments to be less iterative.

Still, further, it would also be desirable to have a system and system that optimizes the amount of data collected at the right intervals that is useful as a robust and valued pipeline for decision making on the operation of physical objects.

In some embodiments, the disclosed system advantageously fills these needs and address the aforementioned deficiencies by providing an integrated structuring that delivers reliable and continuous operation and employs corrective measures for factors that are affecting uptime.

In one embodiment, the system is made up of the following components:

(1) a set of screens for the Operations users to configure data collection frequency and other important parameters, and

(2) a component that constantly reads the messages from each sensor, understands control messages for sensors and other devices in the field, and interprets any actions to be taken to keep them running. For example, if the battery of a sensor is detected low, it sends a communication to the field personnel to replace the battery. These components are connected to each other and they act harmoniously to achieve the desired result of high uptime and high-quality data pipeline.

In some embodiments, the method is made up of the following executable steps:

(1) Read Data message-implicitly understand that the sensor is working. Check if enrichment is required for the data. Perform range checks and enrichments. If data indicates a possible error in sensors-take steps to correct errors with field support and vendor support.

(2) Read Control message—this indicates the health and performance status of sensor and gateway. Take appropriate steps necessary to make them continue to run.

(3) The method also employs the function of an inactivity watchdog to detect that the sensor has lost communication capability. When the inactivity timer expires, the system notifies the field personnel to make the sensor communicate and start producing data again. Such a timer is maintained for every sensor to make sure each sensor operates to produce a desired quality data pipeline.

In some embodiments, the system may also have one or more of the following optional components:

(1) A field component that can run on various operating systems and communicate with the central structuring element. This helps in sending messages at a pre-defined frequency, sending messages synchronous with other sensors, debouncing logic to drop excessive messages of the same type within a time interval to prevent loading the network, and sending messages only when the physical object is operating.

(2) A method that provides the actual performance data back to the users to understand the manufacturing and installation specific variations in performance.

In some embodiments, the disclosed system is unique when compared with other known systems, methods, and solutions in that it provides a fully defined autonomous system to maintain the uptime of the sensors with clearly defined methods to resolve the deficiency between operations mapped to internal (e.g., environmental, installation, or configuration) matters and operations mapped to external (e.g., manufacturing-related supply chain) matters. Similarly, the system disclosed is unique when compared with other known solutions in that it provides the lowest cost to operate with and try different business use cases.

In some embodiments, the disclosed system is unique in that the overall architecture of the system is different from other known systems. More specifically, it provides one or more of the following unique features, individually or collectively, to deliver high integrity of data sourcing in operations, like no other existing solution in the industry:

(a) a method to define operational parameters;

(b) an optional field component to overcome the limitations of gateway or other edge processing systems to run efficiently;

(c) a processing logic that acts on events and takes resolution actions and tracks till completion-providing visibility of what the state and status of each sensor is;

(d) an API or similar connecting component for a business application to obtain state, status, readings and transitions to make it business relevant;

(e) a method to use the date code and other techniques for validity of data when working data is obtained periodically with video images. Such date coding is used to alert the need for recapture of data if it is beyond validity; and

(f) a method for working with APIs on the throttling and frequency in which information is updated for effective use to ensure the structuring is in an orderly fashion when dealing with such data.

The present invention is directed to dynamic source and structured data integration within a real-time data science platform.

A comprehensive, multi-dimensional, integrated platform allows for the design, deployment, and/or configuration of a database to enable the lifecycle operation of sourcing data for physical objects (e.g., “Physical Things” within an IoT context) that mirror their attributes and behavior. Adding various manufacturing data, installation data, configuration data and performance data defined in the database allows arriving at an accurate, perfect or near-perfect representation. The system would become better over time with more samples of data collected and analyzed and a continuously improving system for similar operation.

In some embodiments, a database is included which includes one or more of the manufacturing details, installation details, and configuration details for a set of sensors mapped to represent the physical object. In some embodiments, the system allows users to configure them at various levels of granularity, including, e.g., at a location, equipment, component, or sub-component level of granularity.

In some embodiments, the database defines the digital twin as, e.g., “Redundant”, “Unique” or “Synchronized” with respect to other sensors to enhance the definition of the digital twin and its role in producing a data pipeline for use.

In some embodiments, the system is configured to share the definition for structured data integration components capable of interpreting the nature of the data to produce a robust pipeline for operational use.

In some embodiments, the system allow for tagging (or labeling) of data for one or more machine learning (hereinafter “ML”) modules which are part of the real-time data science platform. Such ML modules may employ various ML methods to analyze performance by, e.g., all locations, selected locations, or a location for all mappings.

In some embodiments, the system obtains actual performance data that can used by users or customers to make more precise definitions and implementations of the sources to make them mirror the physical object.

In some embodiments, the system presents various dimensions of statuses and statistics against the defined sources in Operations, allowing users to make informed changes to the definitions.

In some embodiments, the system enables structuring the source of data to ensure continuity and reliability using the source type, producing a high-quality data pipeline.

In some embodiments, the present invention is directed at capturing and using states on devices (including, e.g., mobile phones, tablets and/or general purpose computers) that have machine data on them or devices connected to them that, if sent to the cloud and structured with other data, would provide valuable insights to operations using real-time data science techniques.

In various embodiments, devices may include, for example.: a mobile device that has native information, connectivity information, and applications that produce digital states usable as data; a mobile phone that has various connectivity options, which can connect on demand and synchronize to gather information that can be used as data; a computer device that has native information, connectivity information, and applications that produce digital states usable as data; a computer that has various connectivity options and which can connect on demand and synchronize to gather information that can be used as data; or any other suitable device that has a standard way to be used in computing/communication framework and can publish data of its own hardware, other onboard applications, and other information using its communication capability.

In some embodiments, the system can include a set of libraries and modules that can process data and communicate to the cloud in a secure fashion.

In some embodiments, various parameters are configured to indicate, at the cloud, what processing and reasoning is to be performed for each state, as well as further usage and distribution.

In some embodiments, the software uses all of the above to produce a pure digital process for the states to be used as data with a series of measurements.

In one exemplary embodiment, the system is made up of the following components:

(1) A user interface (hereinafter “UI”) to configure the operational parameters.

(2) A UI to view the performance of the sources—such as, e.g., sensors, APIs, or database connectors.

(3) A UI to obtain a report of all pending actions for sensors that are not working.

(4) A processing engine that understands the messages and takes appropriate steps to correct errors in any of the sensors or gateways.

(5) A processing engine that interprets the source data semantically and performs the enrichment function per the configuration.

In some embodiments, one or more instructions may be provided to one or more processors to perform the following executable steps, particular when one or more hardware sources from an unstructured environment are involved:

(1) Identify source uptime and availability.

(2) Using a source hierarchical model, determine the operational condition of the physical object to manage operations.

(3) Use source uptime and performance to estimate the vulnerability to failures of similar components in a network of similar or related sources. If it's a physical sensor, the source's output and also its residual life can vary over a period of time, under various environmental conditions.

(4) Employ a configurable control procedure to decide when the source should send or not send data to the cloud to manage efficiency.

(5) Configure the state of the source as maintenance mode or operational mode. In maintenance mode, there will be no data generated by the source or device. In operational mode the data will be generated as per define control procedure.

(6) Obtain and maintain certain operational data such as, e.g., batch numbers for source, or hardware and build version for software for sensors X. Use the actual sensor performance data that is producing pipeline to assess they are performing per expectation Y. Use consistent nonperformance and map with similar source sensors with characteristics of X and recommend replacement techniques for vulnerability of possible downtime or abnormal behavior of sensors.

(7) Modify sensor configuration based on detected anomaly or as required for operationally changed conditions. In some embodiments, this is performed remotely at least in part.

(8) Track sensor data over a period of time and analyze deviation based on operational time, and notify and take a defined decision to trigger a preventive event and operational internal and any 3rd party supplier workflow to manage the sensor.

(9) Monitor each supplier's contribution in the sensor network and determine the areas of non-performance to manage contracts.

(10) Store relevant previous sensor attribute data for future correlation with current sensor type to predict the future performance of the sensor.

(11) Perform a step-by-step procedure to debug sensor configuration and compare to the standard configuration and autonomously reconfigure to the correct parameters from the deviated parameters or attributes with proper notification and capturing event logs.

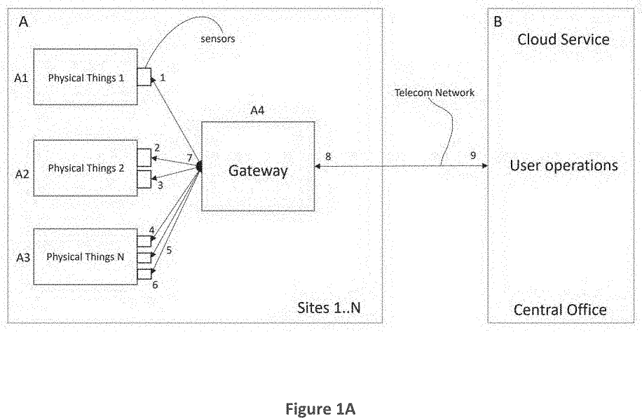

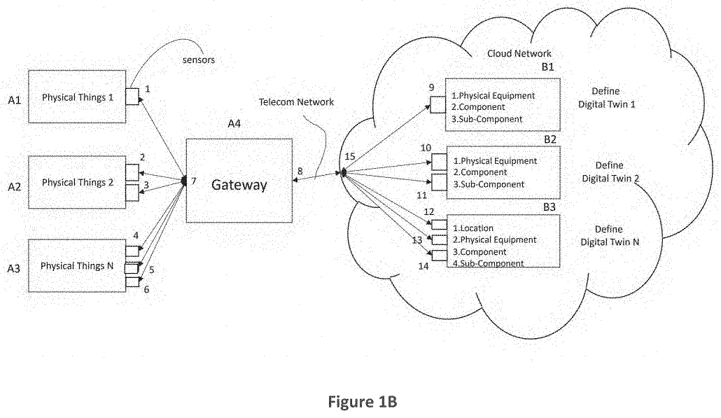

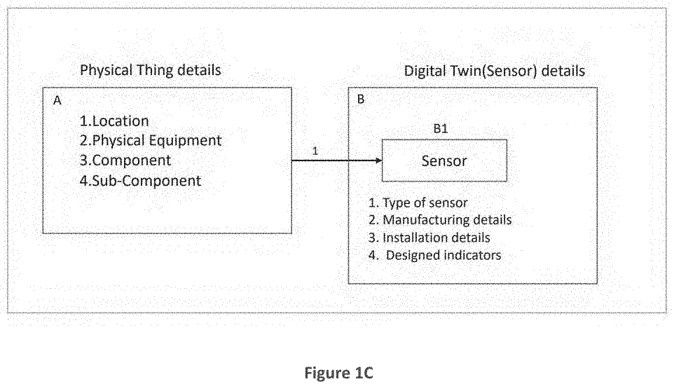

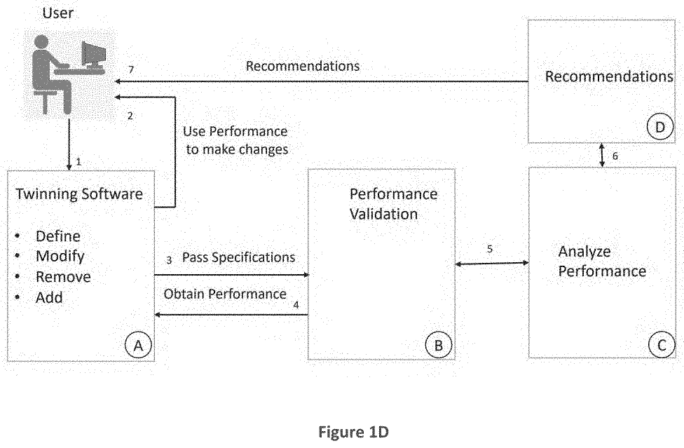

FIG. 1A is a diagram illustrating obtaining data based on defined source sensors, in accordance with some embodiments. The figure shows how the data is obtained if the source sensors are defined. A set of physical components are mapped to sensors that are expected to produce data that reflects the operation of the physical objects. In a system such as IoT, these are connected to a central server called the cloud where a detailed database about the digital twin is maintained for subsequent operation.

FIG. 1B is a diagram illustrating obtaining granular data for physical objects mapped to sensors, in accordance with some embodiments. Mapping can occur at the location level, equipment level, component level, or sub-component level. Such granularity helps in Operations to use the data represented by the digital twin to represent a portion of the physical object as accurately as possible.

FIG. 1C is a diagram illustrating maintaining details of sensors and a gateway, in accordance with some embodiments. The figure shows the details of the sensors and gateway kept in the central database. Manufacturer details, installations details and configuration mapping details are maintained so that every possible combination of these parameters can be analyzed for its contribution to a robust data pipeline.

The details include, e.g., the type of sensor (analog or digital), the type of data it produces (e.g., binary or continuous measurement), the manufacturing details including batch number, manufacturing date. Performance parameters such as the mean time between failures, as well as battery life (if the sensor is running on battery) are maintained in the database.

FIG. 1D is a diagram illustrating methods of reconfiguring a sensor definition after operational experience, in accordance with some embodiments. The figure shows the possible ways of reconfiguring the sensor definition after operational experience. The feedback after running the sensor(s) for a period of time in Operations will provide details of similar sensors that may be needed to improve the precision in operation. Such data is possible to be derived using the knowledge-based analytics on the sensor operational parameters.

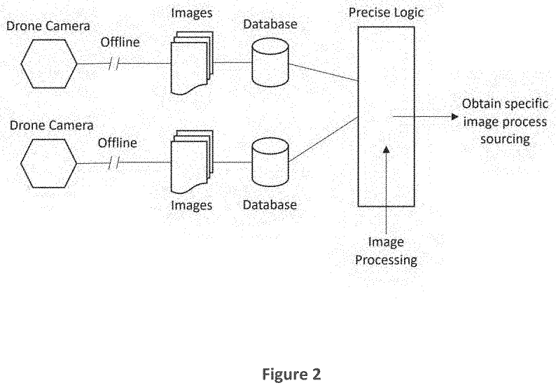

FIG. 2 is a diagram illustrating connecting to image processing systems to obtain states of physical objects for performing actions, in accordance with some embodiments. The figure shows images from drones and camera, and in particular shows how the system connects to image processing systems to obtain the state of physical objects to perform actions. The methods employed include date code of the image capture and other operation-specific details in the image processing to produce high-quality structuring of data for use in operations using a data science platform.

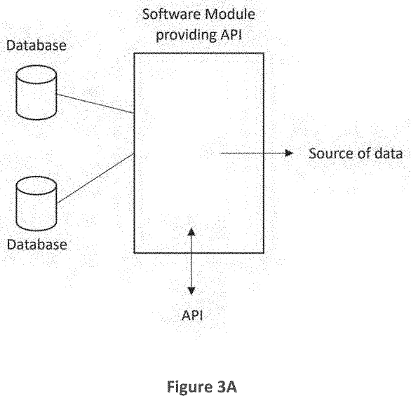

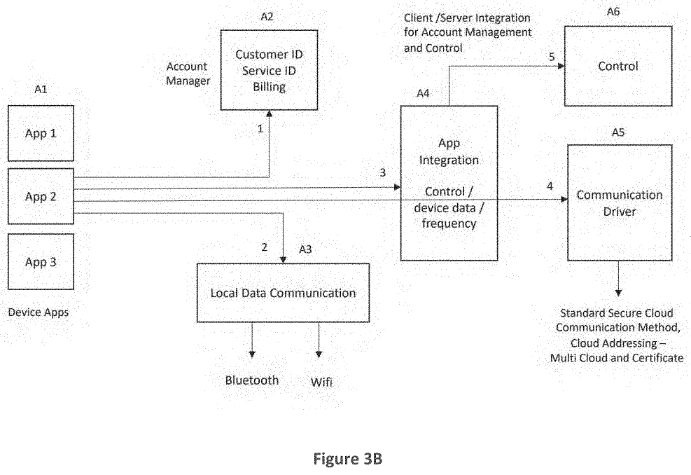

FIG. 3A is a diagram illustrating obtaining data from an API for sourcing and structuring purposes, in accordance with some embodiments.

FIG. 3B is a diagram illustrating sourcing data from standard computing devices, in accordance with some embodiments. Devices may include, e.g., mobile phones, tablets, and/or personal computers or servers. The figure shows a device that is setup to capture various sensory data on device, application states as data and communicate to the cloud. It also shows the local communication module which obtains data using Bluetooth, Wi-Fi, and/or other communication methods and uploads the data using a standard communication framework to the cloud. It may also include an account management function for usage of the cloud service and to configure how to use the various data sent to the cloud. The module also learns the method to publish the data in a standard framework to be usable on the Internet and within the cloud environment.

In various embodiments, such collection can be performed using a native application on the device or a progressive web application method on the cloud to obtain the data, depending on the sourcing method that best suits the desired operation.

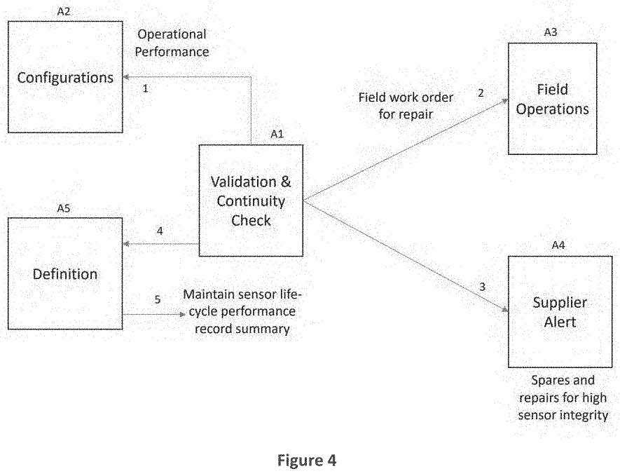

FIG. 4 is a diagram illustrating a function to provide continuity of source data, in accordance with some embodiments. In some embodiments, the customer or user can configure operational parameters such as, e.g., the frequency of data collection and actions to perform if the data from the source is not continuous. The range of data values for the value source is expected to produce linear values.

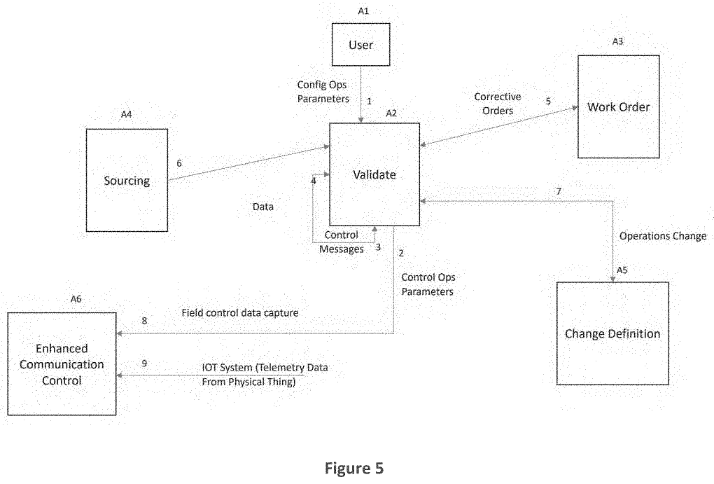

FIG. 5 is a diagram illustrating validation and verification of acceptable data ranges for structuring the data into further processing operations, in accordance with some embodiments. The figure shows the way the software checks the source and validates to be in acceptable range to be ready for structuring into further processing for advanced data science operations. The data is received by the software and then if there is a specific action required to be managed in the field, it issues a field work order to initiate the action, and tracks this field work order until completion.

This illustration also includes handling of missing data or invalid ranges by issuing notifications to improve the continuity or valid values of source data, in accordance with some embodiments. This figure shows how the missing data or invalid ranges are handled by issuing notifications to improve the continuity or valid values of source data to be useful for operations.

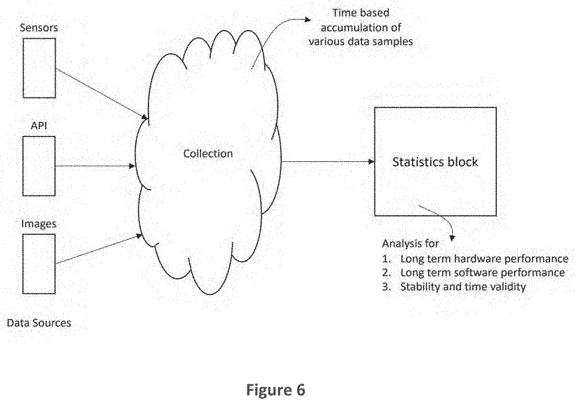

FIG. 6 is a diagram illustrating collection of statistics for providing a snapshot view of consistency and reliability of data sources, in accordance with some embodiments. Such data is useful in arriving at the trustable nature of data specially when various types of inputs are used, some structured and some unstructured.

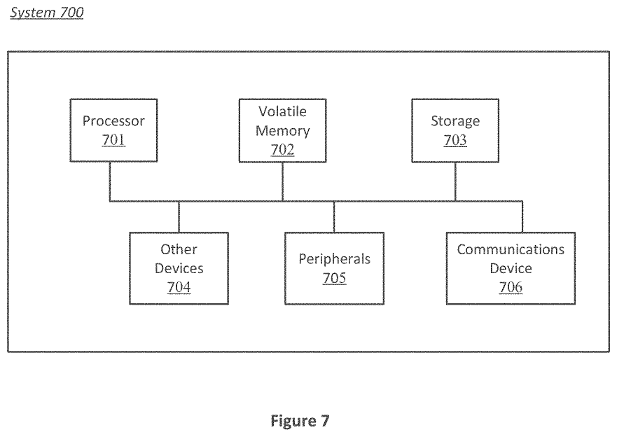

FIG. 7 is a diagram illustrating an exemplary computer that may perform processing in some embodiments. Exemplary computer 700 may perform operations consistent with some embodiments. The architecture of computer 700 is exemplary. Computers can be implemented in a variety of other ways. A wide variety of computers can be used in accordance with the embodiments herein.

Processor 701 may perform computing functions such as running computer programs. The volatile memory 702 may provide temporary storage of data for the processor 701. RAM is one kind of volatile memory. Volatile memory typically requires power to maintain its stored information. Storage 703 provides computer storage for data, instructions, and/or arbitrary information. Non-volatile memory, which can preserve data even when not powered and including disks and flash memory, is an example of storage. Storage 703 may be organized as a file system, database, or in other ways. Data, instructions, and information may be loaded from storage 703 into volatile memory 702 for processing by the processor 701.

The computer 700 may include peripherals 705. Peripherals 705 may include input peripherals such as a keyboard, mouse, trackball, video camera, microphone, and other input devices. Peripherals 705 may also include output devices such as a display. Peripherals 705 may include removable media devices such as CD-R and DVD-R recorders/players. Communications device 706 may connect the computer 700 to an external medium. For example, communications device 706 may take the form of a network adapter that provides communications to a network. A computer 700 may also include a variety of other devices 704. The various components of the computer 700 may be connected by a connection medium 710 such as a bus, crossbar, or network.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to patent claims.

What is claimed:

1. A method for providing intelligent quantification of business phenomena for a business, the method comprising:
identifying an uptime and availability for a data source;
determining an operational condition for a physical object, wherein the data source is configured to obtain performance data for the physical object;
using the uptime for the data source and the performance data for the physical object to predict a vulnerability to failure of one or more similar components in a network of additional data sources that are similar or related to the data source;
employing a configurable control procedure to determine when the data source should send data to a cloud location; and
configuring the state of the data source as one of a maintenance mode or an operational mode.

2. The method of claim 1, wherein the data source comprises a sensor.

3. The method of claim 1, wherein the performance data for the physical object is obtained using a source hierarchical model.

4. The method of claim 1, further comprising:
receiving operational data for the data source;
assessing whether the operational data indicates the data source is performing to a designated expectation; and
recommending, based on an assessment of consistent non-performance to the designated expectation of the received operational data, one or more replacement techniques for vulnerability of possible downtime or abnormal behavior of data sources.

5. The method of claim 1, further comprising:
modifying a data source configuration based on a detected anomaly or as required for operationally changed conditions;
tracking data obtained from the data source over a period of time and analyzing deviation of the data based on operational time; and
providing notification of a defined decision to trigger a preventive event to manage the data source

6. The method of claim 1, further comprising:
monitoring each supplier's contribution in the network of additional data sources; and
determining, with respect to the suppliers' contributions, one or more areas of non-performance to a designated expectation to manage contracts.

7. The method of claim 1, further comprising:
storing relevant previous data source attribute data for future correlation with a current data source type to predict the future performance of the data source.

8. The method of claim 1, further comprising:
debugging a data source configuration, the debugging comprising:
comparing the data source configuration to a standard configuration, and
autonomously reconfiguring the data source to the correct parameters from the deviated parameters or attributes with proper notification; and
capturing one or more event logs relating to the reconfiguring of the data source.

9. A communication system comprising one or more processors configured to perform the operations of:
identifying an uptime and availability for a data source;
determining an operational condition for a physical object, wherein the data source is configured to obtain performance data for the physical object;
using the uptime for the data source and the performance data for the physical object to predict a vulnerability to failure of one or more similar components in a network of additional data sources that are similar or related to the data source;
employing a configurable control procedure to determine when the data source should send data to a cloud location; and
configuring the state of the data source as one of a maintenance mode or an operational mode.

10. The communication system of claim 9, wherein the data source comprises a sensor.

11. The communication system of claim 9, wherein the performance data for the physical object is obtained using a source hierarchical model.

12. The communication system of claim 9, wherein the one or more processors are further configured to perform the operations of:
receiving operational data for the data source;
assessing whether the operational data indicates the data source is performing to a designated expectation; and
recommending, based on an assessment of consistent non-performance to the designated expectation of the received operational data, one or more replacement techniques for vulnerability of possible downtime or abnormal behavior of data sources.

13. The communication system of claim 9, wherein the one or more processors are further configured to perform the operations of:
modifying a data source configuration based on a detected anomaly or as required for operationally changed conditions;
tracking data obtained from the data source over a period of time and analyzing deviation of the data based on operational time; and
providing notification of a defined decision to trigger a preventive event to manage the data source.

14. The communication system of claim 9, wherein the one or more processors are further configured to perform the operations of:
monitoring each supplier's contribution in the network of additional data sources; and
determining, with respect to the suppliers' contributions, one or more areas of non-performance to a designated expectation to manage contracts.

15. The communication system of claim 9, wherein the one or more processors are further configured to perform the operation of:
storing relevant previous data source attribute data for future correlation with a current data source type to predict the future performance of the data source.

16. The communication system of claim 9, further comprising:
debugging a data source configuration, the debugging comprising:
comparing the data source configuration to a standard configuration, and
autonomously reconfiguring the data source to the correct parameters from the deviated parameters or attributes with proper notification; and
capturing one or more event logs relating to the reconfiguring of the data source.

17. A non-transitory computer-readable medium comprising:
instructions for identifying an uptime and availability for a data source;
instructions for determining an operational condition for a physical object, wherein the data source is configured to obtain performance data for the physical object;
instructions for using the uptime for the data source and the performance data for the physical object to predict a vulnerability to failure of one or more similar components in a network of additional data sources that are similar or related to the data source;
instructions for employing a configurable control procedure to determine when the data source should send data to a cloud location; and
instructions for configuring the state of the data source as one of a maintenance mode or an operational mode.

18. The non-transitory computer-readable medium of claim 17, wherein the data source comprises a sensor.

19. The non-transitory computer-readable medium of claim 17, further comprising:
instructions for receiving operational data for the data source;
instructions for assessing whether the operational data indicates the data source is performing to a designated expectation; and
instructions for recommending, based on an assessment of consistent non-performance to the designated expectation of the received operational data, one or more replacement techniques for vulnerability of possible downtime or abnormal behavior of data sources.

20. The non-transitory computer-readable medium of claim 17, further comprising:
instructions for modifying a data source configuration based on a detected anomaly or as required for operationally changed conditions;
instructions for tracking data obtained from the data source over a period of time and analyzing deviation of the data based on operational time; and
instructions for providing notification of a defined decision to trigger a preventive event to manage the data source
